(19) United States
(12) Patent Application Publication
(10) Pub. No.: US 2019/0037797 A1
(43) Pub. Date: Feb. 7, 2019

(54) Pet Bed Assembly

(71) Applicant: Elizabeth Tepper, Lorain, OH (US)

(72) Inventor: Elizabeth Tepper, Lorain, OH (US)

(21) Appl. No.: 15/666,828

(22) Filed: Aug. 2, 2017

(51) Int. Cl. A01K 1/015

(52) U.S. Cl. CPC A01K 1/0157

(57) ABSTRACT

A pet bed assembly is provided. The pet bed assembly includes an adjustable frame including a plurality of elongated members that are removably attachable to each other by a plurality of connectors. The plurality of elongated members may be attached and detached from each other via the connectors to assemble and disassemble the frame in order to make a smaller or larger frame to accommodate pets of different sizes. One or more fasteners disposed on the plurality of elongated members are configured to removably receive a blanket that covers the entirety of the frame to provide a comfortable area in which a pet can lay.

### BACKGROUND OF THE INVENTION

The present invention relates to beds for pet animals. More specifically, the present invention relates to a portable bed assembly for pets including a frame configured to removably secure a blanket thereto as well as disassemble and assemble in order to form a smaller or bigger frame for differently sized pets.

Dogs and other household pets frequently create their own beds within the home using blankets, cloths, towels, pillows, and whatever other fabric-like materials might be laying around the house. Many dogs typically never lie under the articles, but rather bunch them up and then lay on top of them.

Many other household pets do the same thing and use articles that most homeowners don't want their pets to sleep on. The currently disclosed pet bed provides a portable and comfortable bed including a frame that can be disassembled and assembled as needed. The frame is configured to enable a user to assemble the frame to have a desired size such that the bed can accommodate pets of different sizes. Moreover, the frame includes one or more fasteners for removably securing a blanket thereto.

Other pet beds do not offer a way in which to adjust the size of the bed in order to accommodate animals of different sizes, therefore making them less desirable if intended to accommodate pets of different sizes. Moreover, known pet beds do not include a removably attachable blanket, which enables a user to remove the blanket for easy washing and replacement. Therefore, the result is that the blankets become overly worn and dirty because of the difficulty of washing the bed, which leads the pet to make its own bed out of a household item or in a user's own bed. Because the current bed is portable, can be assembled or disassembled as needed, and is configured to removably secure a blanket thereto, it is economical and easy to use.

### SUMMARY OF THE INVENTION

In view of the foregoing disadvantages inherent in the known types of beds for pet animals now present in the prior art, the present invention provides a pet bed assembly wherein the same can be utilized for providing convenience for the user when providing comfort to his or her pet animal.

In one embodiment of the present invention, the pet bed assembly comprises a frame including a plurality of elongated tubular members, each of the plurality of elongated tubular members including a free end and a connector end. A connector disposed on the connector end is configured to receive a free end of an elongated tubular member. A removably attachable blanket includes a planar member having a surface area larger than a diameter of the frame. A fastener disposed on each of the plurality of elongated tubular members is configured to removably engage the blanket.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the pet bed assembly with the frame in a disassembled configuration.

FIG. 2 shows a partially exploded view of the pet bed assembly with the frame in an assembled configuration.

FIG. 3 shows a close-up view of the connector end of an elongated tubular member receiving the free end of an elongated tubular member of the pet bed assembly.

FIG. 4 shows a perspective view of the pet bed assembly.

### DETAILED DESCRIPTION OF THE INVENTION

Reference is made herein to the attached drawings. Like reference numerals are used throughout the drawings to depict like or similar elements of the pet bed assembly. The figures are intended for representative purposes only and should not be considered to be limiting in any respect.

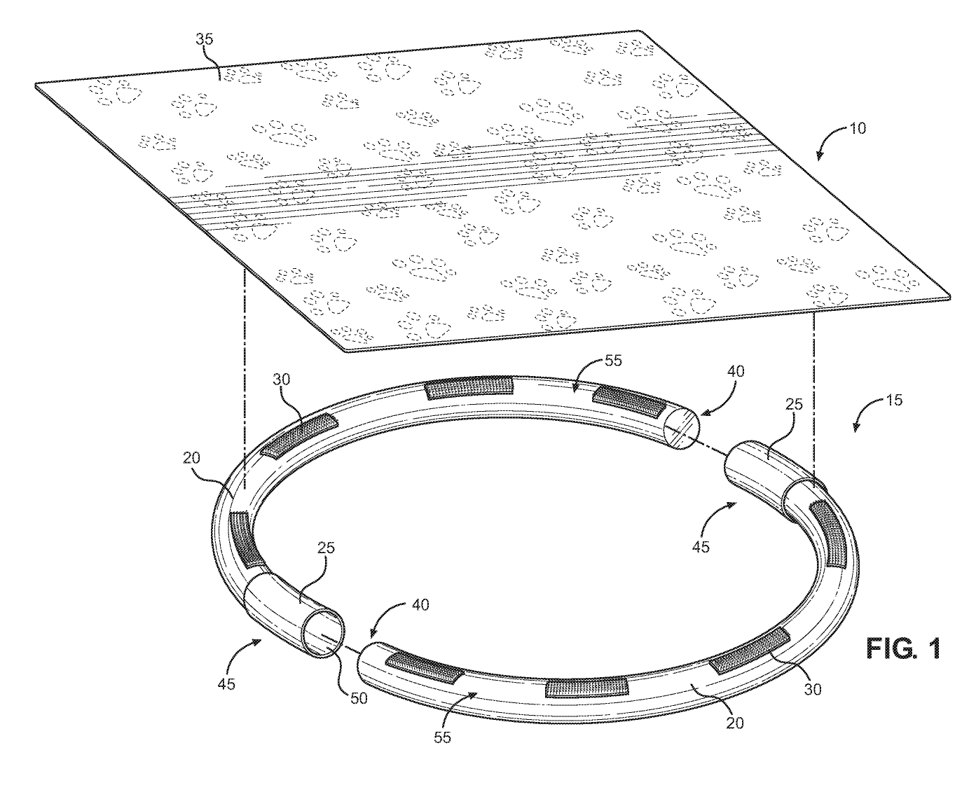

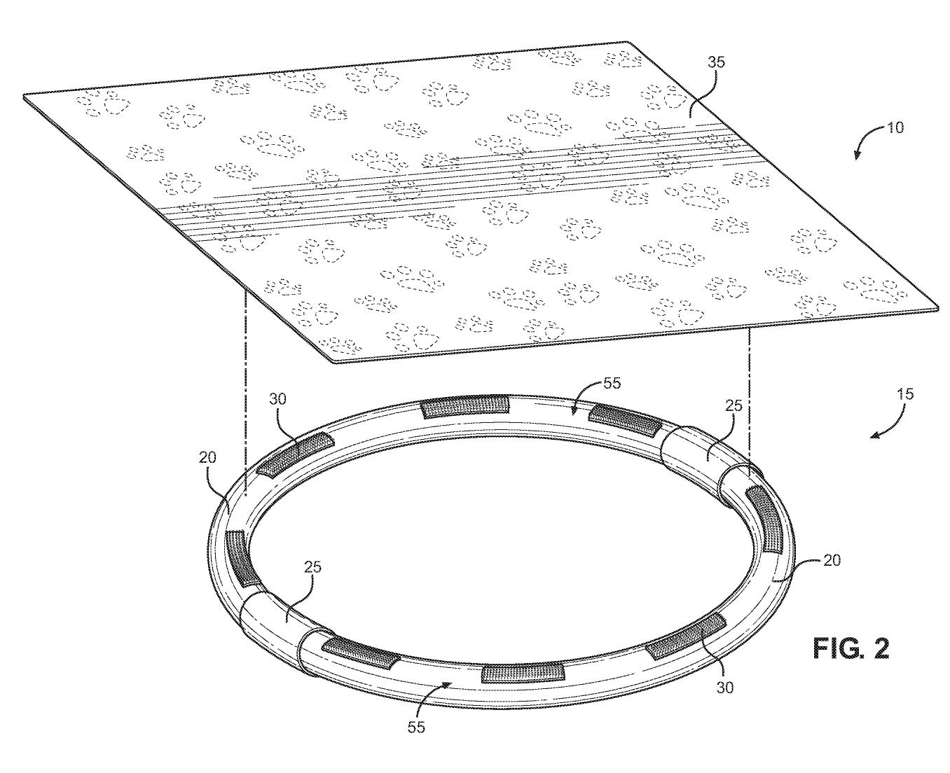

Referring now to FIGS. 1 and 2, there is shown an exploded view of the pet bed assembly with the frame in a disassembled configuration and a partially exploded view of the pet bed assembly with the frame in an assembled configuration, respectively. The present invention provides a pet bed assembly 10 comprising an adjustable frame 15 including a plurality of elongated members 20 that are removably attachable to each other by a plurality of connectors 25. The plurality of elongated members 20 may be attached and detached from each other to assemble and disassemble the frame 15 in order to make a smaller or larger frame 15 to accommodate pets of different sizes. Each of the plurality of elongated members include one or more fasteners 30 that are configured to removably receive a blanket 35.

In the depicted embodiment, each of the plurality of elongated members 20 comprises a tubular member including a flexible padded material, such as polyethylene foam or polyurethane foam. Each elongated member of the plurality of elongated members 20 is configured to flex about a longitudinal axis thereof, which enables the assembled frame 15 to maintain a circular perimeter. Each of the plurality of elongated members 20 includes a free end 40 and a connector end 45 including a connector 25 disposed thereon. The connectors 25 are configured to removably receive a free end 40 of another elongated member 20 therein so as to selectively connect a desired amount of elongated members 20 to one another. In the depicted embodiment, the connectors 25 include tubular couplers disposed annularly about each of the connector ends 45 of the elongated members 20. In another embodiment, the connectors 25 are removably attachable to the connector ends 45 via a friction fit. Each of the tubular couplers comprises an opening 50 including a diameter equal to or greater than a diameter of the free ends 40 of the plurality of members 20, such that the opening 50 is sized to receive a free end 40 therein, as shown in FIG. 2. In one embodiment, the tubular couplers are configured to receive a free end 40 therein via a friction fit. In another embodiment, the tubular couplers include a fastener for removably engaging the free ends 40.

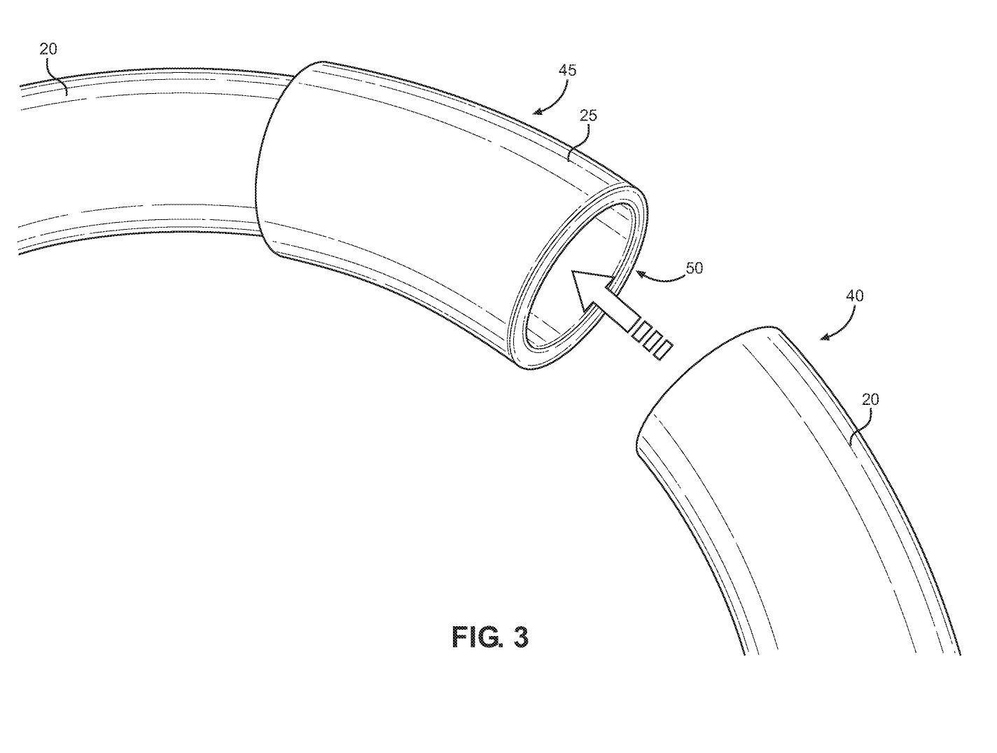

The flexible nature of each of the plurality of elongated members 20 enables each of the elongated members 20 to bend about its own longitudinal access. In this way, each of the plurality of elongated members 20 can bend into an arcuate shape, so as to connect to another elongated member 20 and form an assembled frame 15, as shown in FIG. 3. In operation, a user can select a desired number of elongated members 20 to connect to one another and form frames including different diameters, so as to accommodate pets of different sizes.

The one or more fasteners 30 are disposed on an upper end 55 of each of the plurality of elongated members 20 and extend longitudinally along a linear length of each of the plurality of elongated members 20. In this way, each of the plurality of elongated members 20 includes a hook and loop fastener 30 for facilitating securement of the blanket 35 to the frame 15. In one embodiment, the one or more fasteners 30 include a hook and loop fastener, such as Velcro®, configured to removably receive fabric materials. In the depicted embodiment, each of the plurality of elongated members 20 includes a plurality of hook and look fasteners 30 disposed at evenly spaced intervals along a length thereof, so as to increase contact with a surface area of the blanket 35 and provide better securement thereto.

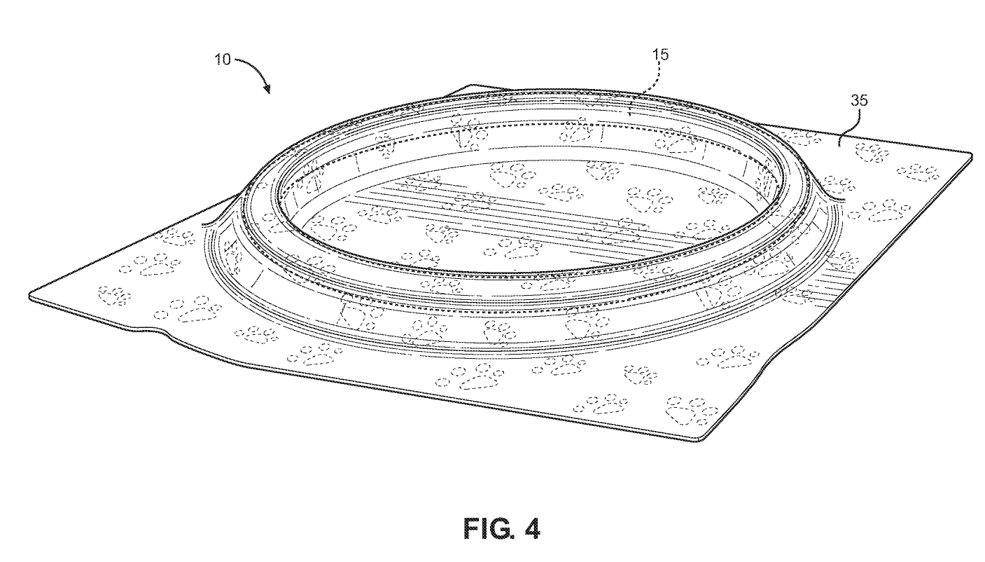

Referring now to FIG. 4, there is shown a perspective view of the pet bed assembly. The blanket 35 comprises a planar member including a supple fabric material, such as cotton, fleece, chenille, and polyester blends, for providing comfort to a pet. The blanket 35 includes a surface area larger than an area of the frame 15, or a surface area larger than a diameter of the frame 15, such that the blanket 35 edges can fully extend over and cover the frame 15 when the blanket 35 is attached thereto. In this way, the frame 15 of the pet bed assembly 10 is configured to be completely concealed by the blanket 35 when the pet bed assembly 10 is in use. In the depicted embodiment, the blanket 35 includes a rectangular planar member. However, in alternative embodiments, the blanket 35 includes different shapes.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet bed assembly, comprising:
a frame including a plurality of elongated members, each of the plurality of elongated members including a free end and a connector end, the connector end including a connector configured to receive a free end of an elongated member of the plurality of elongated members;
a blanket including a planar member having a width larger than a diameter of the frame;
a fastener disposed on each of the plurality of elongated members, the fastener configured to removably engage the blanket for removably securing the blanket to the frame.

2) The pet bed assembly of claim 1, wherein each of the plurality of elongated members is tubular and includes a flexible material, wherein each elongated member of the plurality of elongated members is configured to flex about a longitudinal axis thereof.

3) The pet bed assembly of claim 2, wherein the flexible material includes polyethylene foam.

4) The pet bed assembly of claim 1, wherein each connector includes tubular couplers disposed annularly about the connector end of the plurality of elongated members, the tubular couplers including an opening including a diameter greater than or equal to a diameter of the free end, such that the opening is configured to removably receive a free end of an elongated member of the plurality of elongated members.

5) The pet bed assembly of claim 4, wherein the tubular connectors are removably attachable to the connector end via friction fit.

6) The pet bed assembly of claim 1, wherein the fastener includes a plurality of fasteners disposed on an upper end of each of the plurality of elongated members, the plurality of fasteners extending longitudinally along a length of each of the plurality of elongated members, wherein the plurality of fasteners are disposed at evenly spaced intervals along the length of each of the plurality of elongated members.

7) The pet bed assembly of claim 1, wherein the fastener comprises hook and loop fasteners.

8) The pet bed assembly of claim 1, wherein the blanket includes a fabric material.
